(19) United States
(12) Patent Application Publication
(10) Pub. No.: US 2025/0238753 A1
(43) Pub. Date: Jul. 24, 2025

(54) SMART STAGING AND DELIVERY

(71) Applicant: TARGET BRANDS, INC., Minneapolis, MN (US)

(72) Inventors: Sujata Dutta, Minneapolis, MN (US); Steven Holmstrom, Minneapolis, MN (US)

(21) Appl. No.: 18/944,164

(22) Filed: Nov. 12, 2024

Related U.S. Application Data
(60) Provisional application No. 63/622,325, filed on Jan. 18, 2024.

(51) Int. Cl. G06Q 10/0836; G06Q 10/0631; G06Q 10/0639

(52) U.S. Cl. CPC G06Q 10/0836; G06Q 10/06316; G06Q 10/06398

(57) ABSTRACT

Computer-implemented methods and systems for increasing order fulfillment efficiency for curbside or in-store pickup at a retail store are provided. A smart staging and delivery (SSD) engine can identify and prioritize curbside and in-store pickup staging and delivery tasks for employee(s) of a retailer so that an order can be brought to a guest within a minimal amount of time. In particular, the SSD engine can create and display tasks on a SSD graphical user interface (GUI) to maximize employee efficiency and improve the guest experience. The SSD engine can place accountability to achieve desired wait time results on the SSD engine itself rather than on employee(s) or employee team leaders.

### FIELD

This disclosure relates generally to architecture of computer systems, communication between computing devices, and graphical user interfaces for increasing order fulfillment efficiency for curbside and in-store pickup.

### BACKGROUND

The ease of purchase and order fulfillment experiences can be a key contributor to consumer decisions to purchase from one particular retailer over another. Reducing the time required for staging and delivering orders for curbside or in-store pickup is desirable.

### SUMMARY

This disclosure relates generally to architecture of computer systems, communication between computing devices, and graphical user interfaces for increasing order fulfillment efficiency for curbside and in-store pickup.

The embodiments disclosed herein can identify and prioritize curbside and in-store pickup staging and delivery tasks for employee(s) (i.e., team member(s)) of a retailer so that an order can be brought to a guest within a minimal amount of time (e.g., 2-3 minutes).

In particular, a smart staging and delivery (SSD) engine can create and display tasks on a SSD graphical user interface (GUI) to maximize employee efficiency and improve the guest experience. The SSD engine can place accountability to achieve desired wait time results on the SSD engine itself rather than on employee(s) or employee team leaders.

In some embodiments, the SSD engine can create ideal staging and delivery tasks on a SSD GUI and then assign each of the staging and delivery tasks to one or more employees in a way to increase employee efficiency and reduce guest wait time. In some embodiments, the staging and delivery tasks can be made available to employees on the SSD GUI to allow the employees to select which staging task or delivery task they want to perform next.

In some embodiments, the SSD engine can obtain guest input data, order input data, and employee input data. The SSD engine can generate and display a staging task list and a delivery task list on a SSD GUI based on the guest input data, the order input data and the employee input data. The SSD engine can measure employee performance, store leadership and performance of the SSD engine itself. The SSD engine can also modify task priorities to different guests based on fairness considerations including, for example, the amount of time each guest is waiting for their order.

In some embodiments, the staging task list can include batches of bags and items to retrieve that are sequenced to maximize time efficiency and increase the number of orders that are ready for curbside or in-store pickup when guests arrive. This can include a staging task that includes staging bags and items for different guests to improve time efficiency.

In some embodiments, the delivery task list can include batches of orders to be delivered that result in maximizing the percentage of guests that wait no longer than an acceptable amount of time (e.g., 2 to 3 minutes).

In some embodiments, the SSD engine can display a single task on a SSD graphical user interface (GUI). The single task can be specific to that particular employee. The employee can, via the SSD GUI, accept or reject the task. The task can include information including the amount of time estimated for the task to be completed. If the employee accepts the task, via the SSD GUI, the SSD engine can track the amount of time taken for the employee to complete the task. If the employee rejects the task, via the SSD GUI, the SSD engine can remove the employee from the queue of available employee for performing SSD tasks.

In some embodiments, the SSD engine can monitor and measure performance for each of the employee, the retail store leadership, and the SSD engine itself. In some embodiments, the SSD engine can modify priority of completing particular tasks based on fairness to different guests. Fairness can be based on, for example, the amount of time each guest is waiting for their order.

In one embodiment, a computer-implemented method for increasing order fulfillment efficiency for curbside or in-store pickup at a retail store is provided. The method includes a SSD engine receiving a plurality of orders for curbside delivery or in-store pickup at the retail store. The method also includes the SSD engine obtaining guest input data for each of a plurality guests associated with each of the plurality of orders. Also, the method includes the SSD engine obtaining order input data for each of the plurality of guests. Further, the method includes the SSD engine obtaining team member input data regarding each of one or more SSD employees assigned to staging and delivering curbside and in-store pickup orders at the retail store. The method further includes the SSD engine generating a prioritized sequence of staging tasks based on the guest input data, the order input data and the team member input data, wherein the prioritized sequence of staging tasks includes a plurality of staging tasks. Moreover, the method includes the SSD engine generating a prioritized sequence of delivery tasks based on the guest input data, the order input data and the team member input data, wherein the prioritized sequence of delivery tasks includes a plurality of delivery tasks. The method moreover includes the SSD engine assigning only one task from the combination of the plurality of delivery tasks and the plurality of staging tasks to a first SSD employee of the one or more SSD employees, wherein the one task is assigned by the SSD engine based on the guest input data, the order input data and the team member input data. Also, the method includes the SSD engine instructing a SSD GUI provided on a computing device of the first SSD employee to display the only one task. The method also includes the SSD engine receiving an accept selection, via the SSD GUI, indicating that the first SSD employee has accepted the only one task. The method further includes, upon receiving the accept selection, the SSD engine monitoring progress and completion of the only one task. Further, the method includes, upon completion of the only one task, the SSD engine updating employee performance measurements, store leadership performance measurements, and SSD engine performance measurements based on the SSD monitoring the progress and completion of the only one task.

In another embodiment, a system configured to increase order fulfillment efficiency for curbside or in-store pickup at a retail store is provided. The system includes a SSD engine. The SSD engine is configured to receive a plurality of orders for curbside delivery or in-store pickup at the retail store. The SSD engine is also configured to obtain guest input data for each of a plurality guests associated with each of the plurality of orders. Also, the SSD engine is configured to obtain order input data for each of the plurality of guests. The SSD engine is further configured to obtain team member input data regarding each of one or more SSD employees assigned to staging and delivering curbside and in-store pickup orders at the retail store. Further, the SSD engine is configured to generate a prioritized sequence of staging tasks based on the guest input data, the order input data and the team member input data, wherein the prioritized sequence of staging tasks includes a plurality of staging tasks. The SSD engine is moreover configured to generate a prioritized sequence of delivery tasks based on the guest input data, the order input data and the team member input data, wherein the prioritized sequence of delivery tasks includes a plurality of delivery tasks. Moreover, the SSD engine is configured to assign only one task from the combination of the plurality of delivery tasks and the plurality of staging tasks to a first SSD employee of the one or more SSD employees, wherein the one task is assigned by the SSD engine based on the guest input data, the order input data and the team member input data. The SSD engine is also configured to instruct a SSD graphical user interface (GUI) provided on a computing device of the first SSD employee to display the only one task. Also, the SSD engine is configured to receive an accept selection, via the SSD GUI, indicating that the first SSD employee has accepted the only one task. Further, the SSD engine is configured to monitor progress and completion of the only one task upon receiving the accept selection. Moreover, the SSD engine is configured to update employee performance measurements, store leadership performance measurements, and SSD engine performance measurements based on the SSD monitoring the progress and completion of the only one task upon completion of the only one task.

### BRIEF DESCRIPTION OF THE DRAWINGS

References are made to the accompanying drawings that form a part of this disclosure and which illustrate embodiments in which the systems and methods described in this specification can be practiced.

FIG. 1 illustrates a schematic diagram of a system for facilitating curbside or pickup order fulfillment using a SSD engine, according to one embodiment.

FIG. 2 illustrates a flowchart of a method for identifying and prioritizing staging and delivery tasks for an employee, according to one embodiment.

FIG. 3A illustrates a screenshot of a staging task for a SSD GUI, according to one embodiment.

FIG. 3B illustrates a screenshot of a delivery task for a SSD GUI, according to one embodiment.

FIG. 4 illustrates a schematic diagram of an architecture for a computer device, according to an embodiment.

Like reference numbers represent like parts throughout.

### DETAILED DESCRIPTION

This disclosure relates generally to architecture of computer systems, communication between computing devices, and graphical user interfaces for increasing order fulfillment efficiency for curbside and in-store pickup.

The embodiments disclosed herein can identify and prioritize curbside and in-store pickup staging and delivery tasks for employee(s) of a retailer so that an order can be brought to a guest within a minimal amount of time (e.g., 2-3 minutes).

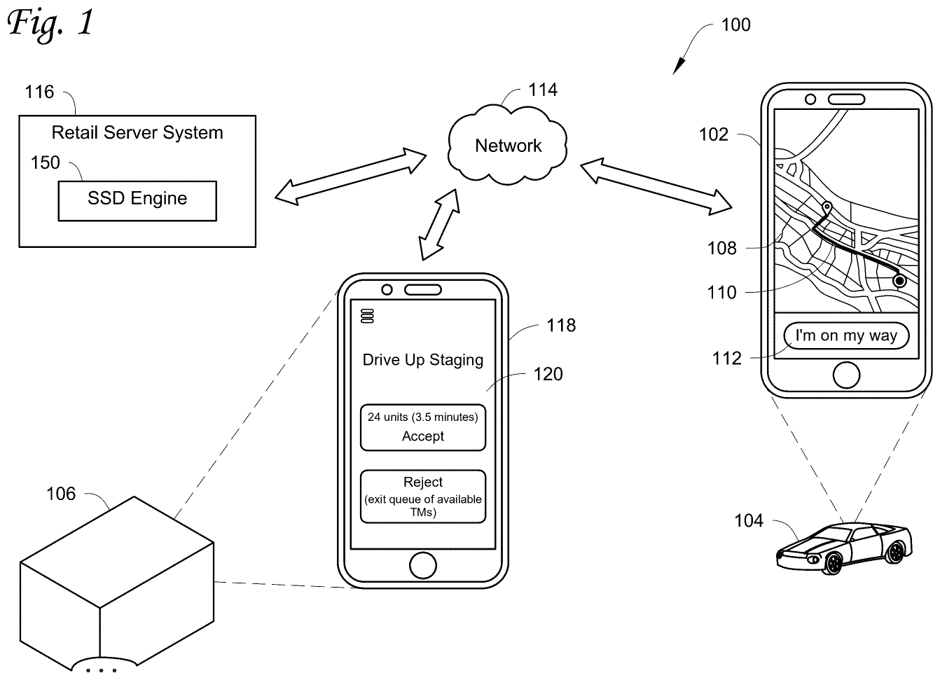

FIG. 1 is a diagram of a system 100 for facilitating order fulfillment for curbside delivery or in-store pickup using a SSD engine 150, according to one embodiment. In the system 100, a guest, such as a customer who wishes to complete an online order for items by picking up the items using a curbside or in-store service, can access a dedicated application executing on a user device 102. The user device 102 shown in FIG. 1 is a mobile device such as, for example, a mobile phone, a tablet device, a touch screen computer, a laptop computer, a PDA, a smart watch, etc. It will be appreciated that the user device 102 can be any type of computing device including a non-mobile or semi-mobile device such as a home computer, etc. In some implementations, instead of accessing a dedicated application executing on the user device 102, the guest can use a browser of the user device 102 to access a website that provides the below described functionality and therefore all descriptions related to use of the dedicated application apply equally to a web-based implementation.

The guest logs into the dedicated application by entering a user name or other identifier and a password. Alternatively, the guest can log into the dedicated application by providing biometric information using one or more sensors of the user device 102 such as by scanning a fingerprint using a fingerprint scanner of the user device 102, using facial recognition software of the user device 102, or using a retina scanner of the user device 102 to scan the guest's retina information. In some implementations, the guest may be already logged into the dedicated application from a previous session.

The guest can use the dedicated application to select items for purchase from a retail store using an online shopping interface. For example, the online shopping application can permit the guest to search and/or browse for clothing items, furniture, toys, linen items, kitchenware, grocery items, etc. The guest can add desired items to a virtual shopping cart, and place an order for the selected items by entering payment information. The guest can also use the dedicated application to access one or more previously entered orders. For example, a guest may have previously logged into an online account for a retailer associated with the dedicated application and placed an on-line order for one or more items using either the user device 102 or a different computing device such as a home or laptop computer. As another example, the guest may have previously placed an on-line order using the dedicated application. The guest can access and review the previously placed orders after logging into the dedicated application. This can include reviewing items included in the orders, estimated time until the order is ready, payment used for the order (e.g., “card ending in 123”), a fulfillment location for the order, and other information associated with the orders.

The user device 102 can communicate with other computing devices through a network 114, such as, for example, the Internet. For example, the user device 102 can communicate with a network access point such as a WiFi router or a cellular communication tower to access the network 114 and communicate with other computing devices. For example, the user device 102 can communicate with a retailer server system 116 consisting of one or more servers to place the order. Alternatively, or additionally, the guest can use a different computer to place the order and the different computer can communicate through the network 114 with the retailer server system 116. The retailer server system 116 can be affiliated with a retailer and process the on-line order received from the user device 102 or another computing device. The retailer server system 116 includes a SSD engine 150. In some embodiments, the retailer server system 116 can include one or more databases or can communicate with one or more databases (e.g., via the network 114) to retrieve data to be used by, for example, the SSD engine 150.

The SSD engine 150 is configured to facilitate fulfillment of the order by providing details of the order, such as ordered items, identity of the guest, an order number, time that the order was placed, etc. to one or more computing devices located at a fulfillment center such as a retail store 106. For example, the retail store 106 can be part of a chain of affiliated stores associated with a retailer and the server system 116 can be a server system associated with the retailer. Upon receiving an on-line order from the guest, the server system 116 can identify the retail store 106 as an appropriate fulfillment location for the order based on information such as, an indication of a preferred location for fulfillment indicated by the guest at the user device 102 or another computing device, a current location of the user device 102, another location associated with the guest (e.g., home or work address information entered by the guest into a customer profile), based on item availability (e.g., by identifying a retail store where all or a majority of the items in the order are in stock), or based on a combination of these and one or more other factors. Upon identifying the appropriate fulfillment location, the SSD engine 150 can identify and prioritize staging and delivery tasks for employee(s) at the appropriate fulfillment location so that orders can be brought to guests within a minimal amount of time (e.g., within 2-3 minutes).

For example, the server system 116 can identify the retail store 106 as an appropriate location for fulfilling the guest's order. Once the appropriate location is identified, the SSD engine 150 can identify and prioritize curbside and in-store pickup staging and delivery tasks for employee(s) so that an order can be brought to a guest within a minimal amount of time.

The SSD engine 150 can transmit information on the order to a computing device 118 in the possession of, or being used by, an employee of the retail store 106. The computing device 118 can be a mobile computing device, such as, for example, a mobile phone, a tablet device, a touch screen computer, a laptop computer, a PDA, a smart watch, or other mobile device. In some implementations, the computing device 118 can be a non-mobile or semi-mobile device such as a server, a desktop computer, a cash register, a smart TV, or other computing device. The SSD engine 150 can provide appropriate information for the order to the computing device 118 via such as items in the order, identifying information for the guest who placed the order, time the order was placed, a desired pickup time for the order (e.g., as indicated by the guest at the time of placing the order), an order number, and other relevant information. In some embodiments, the appropriate information for the order (along with other orders) can be provided on a SSD GUI displayed on the computing device 118.

At the time of placing the order, or at a different time, such as when logging into the dedicated application, the guest using the user device 102 can indicate a desired order fulfillment method for the order. For example, the guest can specify that the order is for curbside fulfillment, for in-store pickup, etc. A curbside fulfillment allows the guest (or a person associated with the guest account) to drive to a fulfillment location, such as a retail store location, a warehouse, or another location where an employee of the retailer can meet the guest at the guest's vehicle 104, verify that the guest is receiving the proper order, and provide the items to the guest without the guest being required to exit their vehicle. For example, the guest can travel to the store 106, park in a designated area of the parking lot of the retail store 106, notify an employee that they have arrived (as described in more detail below), and then receive the purchased items from the employee when the employee brings the items to the guest's vehicle 104.

As another example, the guest can specify that the order is for in-store pickup fulfillment. In-store pickup fulfillment can allow the guest (or a person associated with the guest account) to travel to a fulfillment location, such as the retail store 106, and enter the retail store 106 to pickup the purchased items from a designated location within the fulfillment location. Such a fulfillment method can allow the guest greater flexibility by allowing the guest to shop for additional items within the retail store 106 (e.g., items that the guest wishes to see in-person before purchasing, such as clothing or produce) and then pickup the items from the on-line order at the designated location after completing their in-store shopping. Alternatively, the guest can pickup the order items without also shopping for items at the retail store 106 in person.

As another example, the guest can specify that the order is for delivery. An employee of the retailer or a third-party service can travel to the guest's home or another drop-off location designated by the guest to deliver the items in the order to the guest.

In some cases, when the guest has indicated curbside or in-store pickup type order fulfillment, the dedicated application can provide navigation directions, such as driving directions, to the fulfillment location (e.g., retail store 106). For example, the dedicated application can communicate with a native routing application installed on the user device 102 or with one or more remote routing servers to identify a route from either the guest's current location or a specified starting location to the retail store 106. As another example, the user device 102 can communicate with the server system 116 through the network 114 to receive routing information from either the guest's current location or the specified starting location to the retail store 106. The dedicated application can then, for example, provide a map display 108 showing a route 110 to the retail store 106. As another example, the dedicated application can provide turn by turn directions to the retail store 106 using text and/or icons in addition to or in place of the map display 108.

In some implementations, the guest can permit the dedicated application to access location information for the user device 102. For example, the guest can set a permissions setting permitting the dedicated application to access location information for the user device 102. In some implementations, the guest can specify that the dedicated application is only permitted to access location information for the user device 102 when the dedicated application is executing or can specify that the dedicated application is always permitted to access location information for the user device 102 even when a user interface for the dedicated application is not open. The user device 102 can determine its own location using one or more well-known techniques, such as by using a GPS module for receiving GPS signals from GPS satellites to determine the location of the user device 102. The user device 102 can also use a wireless communication triangulation technique to determine the location of the user device 102. As another example, the user device 102 can determine its location based on the location of a network access point that the user device 102 is in short range wireless communication with (e.g., a WiFi router). The dedicated application can use the location information to identify a starting location for the route 110, such as the current location of the user device 102.

In the case of both curbside and in-store pickup type order fulfillments, the guest can begin to travel to the fulfillment location, such as by driving the vehicle 104 to the retail store 106. In some implementations, information collected or generated by the user device 102 can be used to determine that the guest has begun to travel to the order fulfillment location. For example, location information determined by the user device 102, as described above, can be used to determine that the user device 102 has begun to travel along the route 110. For example, the dedicated application can receive location information for the user device 102 over sequential periods of time (e.g., every 2 seconds) and compare the movement of the user device 102 based on the changing location information to the route 110 to determine that the guest has begun to travel the route 110. Alternatively or additionally, the guest can select a user interface control 112 provided by the dedicated application to indicate that he has begun traveling toward the retail store 106. For example, the guest may have selected a permissions setting to not allow the dedicated application to access location information for the user device 102. In some implementations, the dedicated application will only display the user interface control 112 in situations in which the guest has not permitted the dedicated application to access location information for the user device 102. As another example, the user device 102 may be unable to accurately determine its location, for example, due to tall buildings interfering with GPS signals or due to lack of wireless communications access points in the area around the user device 102. The dedicated application can provide the user interface control 112 when the user device 102 is unable to accurately determine the location of the user device 102 so that the guest can indicate that he has begun to travel toward the retail store 106.

Upon determining that the guest has begun to travel toward the retail store 106 (e.g., based on location information collected by the user device 102 or based on guest interaction with the user interface control 112), the user device 102 can communicate with one or more computing devices located at and affiliated with the retail store 106, either directly through the network 114 or by communicating with the SSD engine 150 which in turn communicates appropriate information and instructions to the one or more computing devices located at the retail store 106. For example, an employee of the retail store 106 can use the computing device 118, which can receive information relevant to the order from the SSD engine 150. The user device 102 can communicate with the server system 116 over the network 114 to indicate to the SSD engine 150 that the guest has begun to travel toward the retail store 106. The SSD engine 150 can then provide a communication to the computing device 118 of the store employee to indicate that the guest of the user device 102 is on the way. The SSD engine 150 may communicate directly with the computing device 118 through the network 114 or may communicate with a computing device/system located at the retail store 106 which then communicates with the computing device 118, e.g., through a wireless or wired local area network (LAN). In some implementations, the SSD engine 150 or a central computing device located at the retail store 106 can communicate with the computing device 118 and one or more other computing devices in possession of other employees of the retail store 106 to allow multiple employees to receive information on on-line orders placed by customers and coordinate efforts to fulfill such orders.

The SSD engine 150 can provide additional information along with this notification or prior to sending the notification that the guest is on the way. For example, the server system 116 can access guest profile information to identify a make and model for the guest's vehicle 104, a color for the guest's vehicle 104, and/or other identifying information for the guest's vehicle 104 (such as a whole or partial license plate number) and provide this vehicle identification information to the computing device 118 to allow the employee to more easily identify the guest's vehicle 104 when the guest has arrived at the designating curbside fulfillment location at the retail store 106. The server system 116 can store this vehicle identification information as part of a customer profile for the guest or the guest can provide the information at the time of placing the order (e.g., in situations where the guest is part of a multi-car family and may use different vehicles on different occasions). In some implementations, the guest can be prompted to enter such vehicle identification information at the time of placing the order, at the time of selecting curbside fulfillment for the order, or at the time of indicating that they are on their way. For example, the dedicated application can present a GUI for eliciting vehicle identification information to the guest at the time of placing the order, or in response to the guest selecting curbside fulfillment or indicating that they are on their way. The GUI can provide guest selectable graphics that allow the guest to indicate different aspects of the vehicle such as color or vehicle type (e.g., SUV, sedan, mini-van, etc.). The GUI can also provide one or more text fields that allow the guest to enter information on the vehicle such as a make and model for the guest's vehicle 104, a color for the guest's vehicle 104, and/or other identifying information for the guest's vehicle 104 (such as a whole or partial license plate number).

The server system 116 can also provide information on an estimated time of arrival and/or an estimated time until arrival for the guest. For example, the user device 102 can calculate an estimated time until arrival for the guest based on the estimated time for traversing the route 110 and provide this information to the server system 116 which can then provide the estimated time until arrival information, via the SSD engine 150, to the computing device 118. As another example, the server system 116 can receive location information from the user device 102 and use this location information to calculate an estimated time until arrival for the guest. For example, the guest can give the dedicated application permission to access location information for the user device 102. A GPS unit or other location detection unit of the user device 102 can regularly determine the location for the user device 102. At the time of indicating to the server system 116 that the guest has begun to travel along the route 110 to the retail store 106, the user device 102 can also indicate the current location of the user device 102. The server system 116 can then use either an internal time estimation routine, or communicate with an external routing system to identify an estimated time required for the guest to travel from the current location of the user device 102 to the retail store 106 using any one of many known techniques. The server system 116 can then provide this estimated time until arrival information, via the SSD engine 150, to the computing device 118, which can then provide this information to the employee.

As the guest travels along the route 110 (or another route) to the retail store 106, the server system 116 can periodically receive updated location information from the user device 102 (e.g., by periodically querying the dedicated application running on the user device 102 for current location information for the user device 102). Each time the server system 116 receives updated location information for the user device 102, the server system 116 can calculate or otherwise identify (e.g., by communicating with the external routing system) an updated estimated time until arrival for the guest, based on the new location information. The server system 116 can then provide, via the SSD engine 150, the updated estimated time until arrival for the guest to the computing device 118. In some implementations, the server system 116 will only provide, via the SSD engine 150, the updated estimated time until arrival for the guest to the computing device 118 if the updated estimated time until arrival differs from the previous estimated time until arrival adjusted for the change in time between the time the initial or previous estimated time until arrival was calculated and the time the updated estimated time until arrival was calculated.

In some implementations, the guest may take a different route to the retail store 106 than indicated by the map display 108. For example, the guest may wish to make a stop along the way to retail store 106 to run a different errand, the guest may have a preferred route to the retail store 106 that is not necessarily the quickest route, the guest may wish to take a more scenic route to the retail store 106, or the guest may wish to a sudden change in traffic conditions due to, e.g., an accident. In such scenarios, the server system 116 can continue to receive periodic location information from the user device 102 and update the estimated time until arrival for the guest based on the new location information for the guest along the new route. In some implementations, if the location of the user device 102 has strayed from the route 110, the server system 116, a remote mapping system, or a mapping application installed on the user device 102 can update the route 110 to indicate a new route from the current location of the user device 102 to the retail store 106 and communicate the updated route to the dedicated application. The dedicated application can then display this updated route on the map display 108.

In some implementations, the user interface of the dedicated application can include one or more additional controls. For example, the guest may travel part way to the retail store 106 and then decide to pick up the order at a different time. The guest can select a control indicating that they are no longer enroute to the retail store 106. The user device 102 can then communicate to the server system 116 that the guest is no longer on the way to the retail store 106. The server system 116 can then, via the SSD engine 150, communicate to the computing device 118 that the guest is no longer on the way to the retail store 106 which can allow the employee to focus efforts on fulfilling a different order or performing other tasks.

The computing device 118 is configured to display a SSD GUI 120. The SSD GUI 120 can, for example, be a user interface for another dedicated application executing on the computing device 118. The SSD GUI 120 is configured to be used by the SSD engine 150 to identify and prioritize curbside and in-store pickup staging and delivery tasks for the employee using the computing device 118 and other employees accessing the SSD GUI 120 via other computing devices so that an order can be brought to a guest within a minimal amount of time.

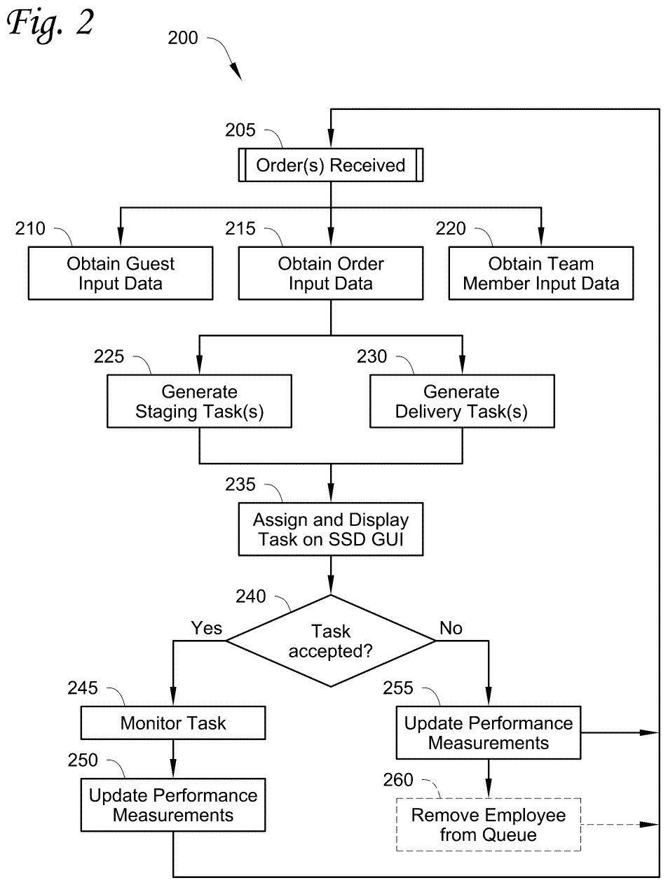

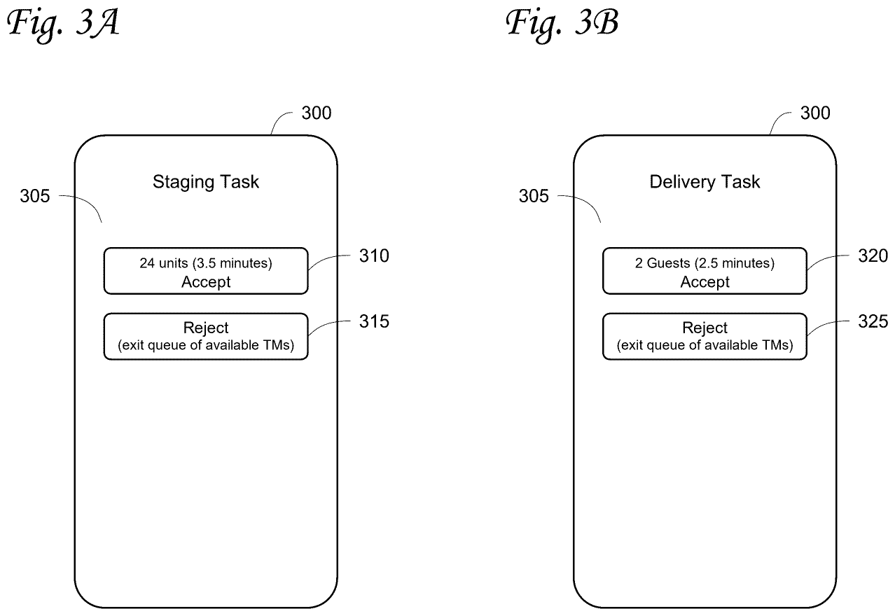

In particular, the SSD engine 150 can create and display tasks on the SSD GUI 120 to maximize employee efficiency and improve the guest experience. The SSD engine 150 can place accountability to achieve desired wait time results on the SSD engine 150 itself rather than on employees or employee team leaders. Details of the SSD engine 150 and the SSD GUI 120 are discussed below with respect to FIGS. 2, 3A and 3B.

FIG. 2 illustrates a flowchart of a method 200 for identifying and prioritizing staging and delivery tasks for an employee, according to one embodiment. In some embodiments, the method 200 can be implemented using the system 100 shown in FIG. 1.

The method 200 begins at 205, whereby an SSD engine (e.g., the SSD engine 150) waits until it determines that one or more curbside or in-store pickup orders have been received. Once received, the method 200 then proceeds concurrently to 210, 215 and 220. It will be appreciated that in some embodiments 210, 215 and 220 are not required to be performed concurrently but can be performed sequentially in any order as required.

At 210, the SSD engine obtains guest input data for each of the one or more curbside or in-store pickup orders at a particular retail store (e.g., the retail store 106 shown in FIG. 1). Examples of guest input data can include: a number of guests that are on their way to the retail store or have arrived at the retail store; a distance or estimated time of arrival to the retail store for each guest; a priority level of each guest based on an On My Way (OMW) notification; multiple order delivery likelihood; etc. In some embodiments, the SSD engine can obtain guest input data from one or more databases included in a retailer server system (e.g., the retailer server system 116 shown in FIG. 1) or accessible by the retailer server system.

At 215, the SSD engine obtains order input data for each of the one or more curbside or in-store pickup orders at the particular retail store. Examples of order input data can include: unit/order types; quantity of each unit/order; cubic volume of each unit/order; hold/current location (batching and optimal retrieval path) data; etc. In some embodiments, a unit can specify how large an order is. This can also be quantified by the number of bags or different hold locations in use for a particular order. In some embodiments, an order type can refer to items/bags that are temperature sensitive (e.g., frozen and refrigerated grocery, vendor food or beverage(s), etc. Hold/current location data can refer to items/bags from different guests that are on their way to the retail store and those items/bags are located close to one another. Hold/current location data can be used by the SSD engine to direct the SSD employee to grab the items/bags for different guests in the shortest route possible top provide the items/bags on the same curbside delivery trip. In some embodiments, the SSD engine can obtain order input data from one or more databases included in a retailer server system (e.g., the retailer server system 116 shown in FIG. 1) or accessible by the retailer server system.

At 220, the SSD engine obtains team member input data for each SSD employee (i.e., each employee assigned to staging and delivering curbside and in-store pickup orders at the particular retail store). Examples of order team member input data can include: number of SSD employees available; task type performance measurements for each available SSD employee indicating how well the SSD employee performs required tasks to fulfill the order(s); recent task type performed by each available SSD employee; task preferences for each available SSD employee; physical restrictions for each available SSD employee; time of year or weather conditions; etc. In some embodiments, task type performance measurements can include, for example, a percentage of tasks completed by the SSD employee within a defined time estimate, a percentage of tasks accepted or rejected by the SSD employee, a percentage of start delays by the SSD employee within a predefined time period, etc. In some embodiments, task preferences can include, for example, staging temperature sensitive units/items versus ambient temperature units/items, staging bulky items, etc. In some embodiments, physical restrictions can include, for example, lift weight restrictions for the SSD employee, any disability restrictions for the SSD employee, etc. In some embodiments, the time of year or weather conditions can be used by the SSD engine to limit how much time a SSD employee is out of the retail store delivering curbside orders (such as when the outside temperature is below 0° F., during a rain storm, etc.) during a set time period (e.g., one hour). In some embodiments, the SSD engine can obtain team member input data from one or more databases included in a retailer server system (e.g., the retailer server system 116 shown in FIG. 1) or accessible by the retailer server system.

The method 200 then proceeds concurrently to 225 and 230. It will be appreciated that in some embodiments 225 and 230 are not required to be performed concurrently but can be performed sequentially in any order as required.

At 225, the SSD engine is configured to process the guest input data, the order input data and the team member input data to generate one or more different staging tasks for one or more of the SSD employees. In some embodiments, the SSD engine can generate a staging task list that includes, for example, a prioritized sequence of staging tasks that can result in maximizing the number of orders ready for curbside delivery and in-store pickup when guests arrive. The sequence can be prioritized, for example, based on various factors including: the perishability of any items (e.g., frozen or refrigerated foods); fairness to different guests based on the amount of time each guest is waiting for their order after having arrived at the store location; etc. In some embodiments, the SSD engine can initially determine priority levels based on On My Way (on my way) notifications received or not received by each of the guests. For example, the SSD engine can use a first in first out (FIFO) sequence for staging tasks based on the sequence in which each OMW notification was received. In some embodiments, the SSD engine can determine for each guest order whether the order can be retrieved using a FIFO sequence before the respective guest arrives. If so, the SSD engine can use the FIFO order to determine the sequence of staging tasks to be completed. If not, the SSD engine can then look to each order that cannot be completed before the guest arrives using the FIFO sequence and determine whether the staging tasks required to complete that order can be moved up in priority without preventing higher priority orders that were determined that could be completed before the respective guest(s) arrives to an order that could not be completed before the guest arrives.

Each staging task in the staging task list can include batches items (for one or more different orders) to be retrieved within the retail store by a SSD employee and batches of orders to be bagged and staged by a SSD employee once items are retrieved for efficient staging of multiple orders. In some embodiments, one or more of the staging tasks can include, for example, retrieving multiple items for different orders that may be located in close proximity to each other within the retail store.

At 230, the SSD engine is configured to process the guest input data, the order input data and the team member input data to generate one or more different delivery tasks for one or more of the SSD employees. In some embodiments, the SSD engine can generate a delivery task list that includes, for example, a prioritized sequence of delivery tasks that can result in maximizing the percentage of guests that receive their order within a set time period upon arrival at the store (e.g., within 2-3 minutes). The sequence can be prioritized, for example, based on various factors including: the perishability of any items (e.g., frozen or refrigerated foods); fairness to different guests based on the amount of time each guest is waiting for their order after having arrived at the store location; etc. For example, in some embodiments, the delivery task list can prioritize staged and ready curbside delivery orders in a sequence based on when each guest arrived at the store location. Each delivery task in the delivery task list can include one or more orders to be delivered at the same time by the SSD employee (e.g., for curbside delivery or for in-store pickup) for efficient delivery of multiple orders.

In some embodiments, guest order data directed to multiple order delivery likelihood can be used by the SSD engine to combine delivery tasks such that multiple curbside deliveries can be performed on the same trip by the SSD employee. For example, if two guests are determined to be on the way to the store location and their respective estimated time of arrival is determined to be within a set time period (e.g., within one minute of each other), SSD engine can determine that multiple curbside deliveries can be achieved in the same curbside delivery trip.

In some embodiments, the priority of delivery tasks can be first prioritized by, for example, a guest arrival timestamp. For example, the SSD engine can first prioritize delivery tasks based on the sequence of each guest arrival timestamp. In some embodiments, the SSD engine can determine for each guest order whether the order can be delivered within a predefined delivery time period (e.g., 3 minutes) based on a guest arrival timestamp sequence. If so, the SSD engine can use the guest arrival timestamp to determine the sequence of delivery tasks to be completed. If not, the SSD engine can then look to each order that cannot be completed within the predefined delivery time period using the guest arrival timestamp sequence and determine whether the delivery tasks required to complete that order can be moved up in priority without preventing higher priority orders that were determined that could be completed within the predefined delivery time period to an order that could not be completed within predefined delivery time period. The method 200 then proceeds to 235.

At 235, the SSD engine assigns and displays a single task (either a staging task from the plurality of staging tasks generated at 225 or a delivery task from the plurality of delivery tasks generated at 230) on a SSD GUI (e.g., the SSD GUI 120 shown in FIG. 1) for a SSD employee to view on their computing device (e.g., the computing device 118 shown in FIG. 1). Each of the SSD employees is assigned, at most, only one staging task list or delivery task list at a time rather than providing the SSD employee multiple tasks for the SSD employee to choose from. The SSD engine will not assign the employee another staging or delivery task until the SSD engine determines that the task is completed. Accordingly, the SSD employee is prevented from choosing a task with a lower priority level over task(s) with a higher priority level and thus maximizing the number of orders ready for curbside delivery and in-store pickup when guests arrive and maximizing the percentage of guests that receive their order within a set time period upon arrival.

FIGS. 3A and 3B illustrates different screenshots of a SSD GUI 305 that displays a single task for a SSD employee to view on their computing device 300. FIG. 3A illustrates an example of the SSD GUI 305 when the SSD engine assigns the SSD employee a staging task. The SSD GUI 305 in FIG. 3A displays an accept button 310 and a reject button 315. Each of the buttons 310, 315 provide information regarding what occurs when selecting the accept button 310 or the reject button 315. For example, the accept button 310 includes information regarding the task to be completed—particularly the number of units to be retrieved and a provided time estimate (i.e., the estimated amount of time required to complete the task). The reject button 315 indicates that the SSD employee will be removed from the list of available SSD employees if selected.

FIG. 3B illustrates an example of the SSD GUI 305 when the SSD engine assigns the SSD employee a delivery task. The SSD GUI 305 in FIG. 3B displays an accept button 320 and a reject button 325. Each of the buttons 320, 325 provide information regarding the accepting or rejecting the task. For example, the accept button 320 includes information regarding the task to be completed—particularly the number of guests to deliver orders for the task and the estimated amount of time required to complete the task. The reject button 315 indicates that the SSD employee will be removed from the list of available SSD employees if selected.

Returning to FIG. 2, the method 200 then proceeds to 240.

At 240, the SSD engine waits for the SSD employee to accept or reject the task displayed on the SSD GUI. In some embodiments, the SSD employee can select an accept button or a reject button displayed on the SSD GUI. For example, the SSD employee can select the accept button 310 shown in FIG. 3A or the accept button 320 shown in FIG. 3B to accept the assigned task. Also, the SSD employee can select the reject button 315 shown in FIG. 3A or the reject button 325 shown in FIG. 3B to reject the assigned task. The SSD GUI can provide the SSD employee's selection to the SSD engine. When the SSD employee accepts the task, the method 200 proceeds to 245. When the SSD employee rejects the task, the method 300 proceeds to 355.

At 245, the SSD engine monitors and waits for the employee to complete the assigned task. The SSD engine can determine that an assigned staging task is completed when the employee, for example, scans a cart after retrieving and scanning bag(s) from the guest(s) order(s). The SSD engine can determine that an assigned delivery task is completed when the employee, for example, returns inside the store location after, when the employee arrives at the guest vehicle and enters a guest code. In some embodiments, the SSD engine tracks the amount of time required by the employee to complete the task based on, for example, when the employee scans the cart after retrieving and scanning bag(s) from the guest(s) order(s) and/or when the employee arrives at the guest vehicle and enters a guest code. When the SSD engine determines that the employee has completed the task, the method 200 proceeds to 250.

At 250, the SSD engine updates employee performance measurements, store leadership performance measurements, and SSD engine performance measurements based on data monitored at 245. The employee performance measurements can include, for example, the percentage of tasks completed by the SSD employee within a provided time estimate, the percentage of tasks accepted or rejected by the SSD employee, the percentage of task start delays within X seconds (e.g., 10 seconds), etc. The employee performance measurements can provide insight as to: whether the SSD employee is completing tasks within the provided time estimate, how often the SSD employee is accepting and rejecting tasks, how much delay the SSD employee incurs before starting tasks, etc. The store leadership performance measurements can include, for example, percentage of orders delivered within a maximum time threshold (e.g., 3 minutes), percentage of orders delivered within a derived time goal (e.g., 2 minutes), percentage of SSD employees completing tasks within the provided time estimate, a ratio of actual SSD employee hours available to the needed SSD employee hours to support staging and delivery of curbside and in-store pickup orders, etc. The store leadership performance measurements can provide insight as to: whether guests are waiting beyond acceptable or desired time goals, whether SSD employees are completing tasks within provided time estimates, whether there is a sufficient number of SSD employees to support curbside and in-store pickup orders, etc. The SSD engine performance measurements can include, for example, the percentage of orders delivered within the maximum time threshold (e.g., 3 minutes), the percentage of orders delivered within the derived time goal (e.g., 2 minutes), the percentage difference between actual time to complete each task and the estimated time to complete each task. The SSD engine performance measurements can provide insight as to: whether guests are waiting beyond acceptable or desired time goals, the accuracy of provided time estimates for tasks, etc. These performance measurements can be used by the SSD engine, for example, to modify team member input data that can be used in future executions of the method 200. It will be appreciated that the provided time estimates for completing tasks can over or under estimate the actual time needed to complete the task. Using performance measurements to optimize how the SSD engine operates can create more accurate and effective staging or delivery of tasks.

In some embodiments, team member performance metrics can include tracking the percentage of tasks completed with a predefined time estimate (e.g., task completion time/estimated completion time). For staging tasks, the task completion time can be the time between the team member accepting the staging task and scanning carts where the last bag/item is placed. For delivery tasks, the task completion time can be the time between the team member accepting the delivery task and when the last guest for the delivery task enters a code indicating that the delivery task is complete. In some embodiments, team member performance metrics can also include tracking the percentage of tasks accepted (e.g., number of tasks accepted/(combination of the number of tasks accepted and the number of tasks rejected)). In some embodiments, team member performance metrics can also include tracking the amount of start delay within a predefined time period (e.g., the time from when the task is created and presented on the team member device until the team member accepts the task).

In some embodiments, store leadership performance metrics can include tracking the percentage of orders delivered within a predefined delivery time period (e.g., 3 minutes). In some embodiments, store leadership performance metrics can also include tracking the percentage of team members completing tasks within an estimated time period for completing the task. In some embodiments, store leadership performance metrics can further include tracking the number of actual hours required for completing tasks versus the ideal number of team member hours required to complete the staging and delivery tasks (e.g., the number of team members logged into SSD engine) versus the calculated ideal number of team members required to meet a predefined staging and delivery goal (e.g., within 3 minutes).

The method 200 returns back to 205.

At 255, the SSD engine updates employee performance measurements, store leadership performance measurements, and SSD engine performance measurements based on the employee rejecting the task at 240. These performance measurements can be used by the SSD engine, for example, to modify team member input data that can be used in future executions of the method 200. In some embodiments, rejecting a task may alert a team leader or other leadership within the retail store. In some embodiments, the SSD engine can request the employee to input a reason for rejecting the task. The method 200 then optionally proceeds to 260 or returns back to 205.

At optional 260, the SSD engine removes the employee from the queue of available SSD employees. The method 200 returns back to 205.

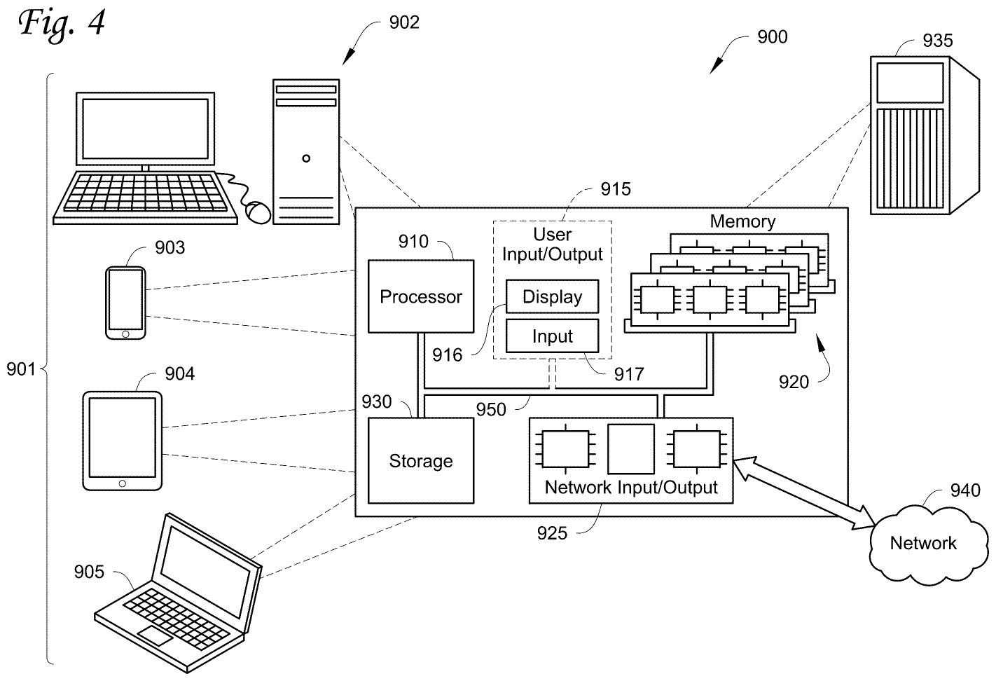

FIG. 4 is a schematic diagram of architecture for a computer device 900, according to an embodiment. The computer device 900 and any of the individual components thereof can be used for any of the operations described in accordance with any of the computer-implemented methods and systems described herein.

The computer device 900 generally includes a processor 910, memory 920, a network input/output (I/O) 925, storage 930, and an interconnect 950. The computer device 900 can optionally include a user I/O 915, according to some embodiments. The computer device 900 can be in communication with one or more additional computer devices 900 through a network 940.

The computer device 900 is generally representative of hardware aspects of a variety of user devices 901 and a server device 935. The illustrated user devices 901 are examples and are not intended to be limiting. Examples of the user devices 901 include, but are not limited to, a desktop computer 902, a cellular/mobile phone 903, a tablet device 904, and a laptop computer 905. It is to be appreciated that the user devices 901 can include other devices such as, but not limited to, a wearable device, a personal digital assistant (PDA), a video game console, a television, or the like. In an embodiment, the user devices 901 can alternatively be referred to as client devices 901. In such an embodiment, the client devices 901 can be in communication with the server device 935 through the network 940. One or more of the client devices 901 can be in communication with another of the client devices 901 through the network 940 in an embodiment.

The processor 910 can retrieve and execute programming instructions stored in the memory 920 and/or the storage 930. The processor 910 can also store and retrieve application data residing in the memory 920. The interconnect 950 is used to transmit programming instructions and/or application data between the processor 910, the user I/O 915, the memory 920, the storage 930, and the network I/O 940. The interconnect 950 can be, for example, one or more busses or the like. The processor 910 can be a single processor, multiple processors, or a single processor having multiple processing cores. In some embodiments, the processor 910 can be a single-threaded processor. In an embodiment, the processor 910 can be a multi-threaded processor.

The user I/O 915 can include a display 916 and/or an input 917, according to an embodiment. It is to be appreciated that the user I/O 915 can be one or more devices connected in communication with the computer device 900 that are physically separate from the computer device 900. For example, the display 916 and input 917 for the desktop computer 902 can be connected in communication but be physically separate from the computer device 900. In some embodiments, the display 916 and input 917 can be physically included with the computer device 900 for the desktop computer 902. In an embodiment, the user I/O 915 can physically be part of the user device 901. For example, the cellular/mobile phone 903, the tablet device 904, and the laptop 905 include the display 916 and input 917 that are part of the computer device 900. The server device 935 generally may not include the user I/O 915. In an embodiment, the server device 935 can be connected to the display 916 and input 917.

The display 916 can include any of a variety of display devices suitable for displaying information to the user. Examples of devices suitable for the display 916 include, but are not limited to, a cathode ray tube (CRT) monitor, a liquid crystal display (LCD) monitor, a light emitting diode (LED) monitor, or the like.

The input 917 can include any of a variety of input devices or input means suitable for receiving an input from the user. Examples of devices suitable for the input 917 include, but are not limited to, a keyboard, a mouse, a trackball, a button, a voice command, a proximity sensor, an ocular sensing device for determining an input based on eye movements (e.g., scrolling based on an eye movement), or the like. It is to be appreciated that combinations of the foregoing inputs 917 can be included for the user devices 901. In some embodiments the input 917 can be integrated with the display 916 such that both input and output are performed by the display 916.

The memory 920 is generally included to be representative of a random access memory such as, but not limited to, Static Random Access Memory (SRAM), Dynamic Random Access Memory (DRAM), or Flash. In some embodiments, the memory 920 can be a volatile memory. In some embodiments, the memory 920 can be a non-volatile memory. In some embodiments, at least a portion of the memory can be virtual memory.

The storage 930 is generally included to be representative of a non-volatile memory such as, but not limited to, a hard disk drive, a solid state device, removable memory cards, optical storage, flash memory devices, network attached storage (NAS), or connections to storage area network (SAN) devices, or other similar devices that may store non-volatile data. In some embodiments, the storage 930 is a computer readable medium. In some embodiments, the storage 930 can include storage that is external to the computer device 900, such as in a cloud.

The network I/O 925 is configured to transmit data via a network 940. The network 940 may alternatively be referred to as the communications network 940. Examples of the network 940 include, but are not limited to, a local area network (LAN), a wide area network (WAN), the Internet, or the like. In some embodiments, the network I/O 925 can transmit data via the network 940 through a wireless connection using Wi-Fi, Bluetooth, or other similar wireless communication protocols. In some embodiments, the computer device 900 can transmit data via the network 940 through a cellular, 3G, 4G, or other wireless protocol. In some embodiments, the network I/O 925 can transmit data via a wire line, an optical fiber cable, or the like. It is to be appreciated that the network I/O 925 can communicate through the network 940 through suitable combinations of the preceding wired and wireless communication methods.

The server device 935 is generally representative of a computer device 900 that can, for example, respond to requests received via the network 940 to provide, for example, data for rendering an online service (e.g., a website, an app, etc.) on the user devices 901. The server 935 can be representative of a data server, an application server, an Internet server, or the like.

Aspects described herein can be embodied as a system, method, or a computer readable medium. In some embodiments, the aspects described can be implemented in hardware, software (including firmware or the like), or combinations thereof. Some aspects can be implemented in a non-transitory, tangible computer readable medium, including computer readable instructions for execution by a processor. Any combination of one or more computer readable medium(s) can be used.

The computer readable medium can include a computer readable signal medium and/or a computer readable storage medium. A computer readable storage medium can include any tangible medium capable of storing a computer program for use by a programmable processor to perform functions described herein by operating on input data and generating an output. A computer program is a set of instructions that can be used, directly or indirectly, in a computer system to perform a certain function or determine a certain result. Examples of computer readable storage media include, but are not limited to, a floppy disk; a hard disk; a random access memory (RAM); a read-only memory (ROM); a semiconductor memory device such as, but not limited to, an erasable programmable read-only memory (EPROM), an electrically erasable programmable read-only memory (EEPROM), Flash memory, or the like; a portable compact disk read-only memory (CD-ROM); an optical storage device; a magnetic storage device; other similar device; or suitable combinations of the foregoing. A computer readable signal medium can include a propagated data signal having computer readable instructions. Examples of propagated signals include, but are not limited to, an optical propagated signal, an electro-magnetic propagated signal, or the like. A computer readable signal medium can include any computer readable medium that is not a computer readable storage medium that can propagate a computer program for use by a programmable processor to perform functions described herein by operating on input data and generating an output.

An embodiment can be provided to an end-user through a cloud-computing infrastructure. Cloud computing generally includes the provision of scalable computing resources as a service over a network (e.g., the Internet or the like).

The terminology used in this specification is intended to describe particular embodiments and is not intended to be limiting. The terms “a,” “an,” and “the” include the plural forms as well, unless clearly indicated otherwise. The terms “comprises” and/or “comprising,” when used in this specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. This specification and the embodiments described are exemplary only, with the true scope and spirit of the disclosure being indicated by the claims that follow.

What is claimed is:

1. A computer-implemented method for increasing order fulfillment efficiency for curbside or in-store pickup at a retail store, the computer-implemented method comprising:
a smart staging and delivery (SSD) engine receiving a plurality of orders for curbside delivery or in-store pickup at the retail store;
the SSD engine obtaining guest input data for each of a plurality guests associated with each of the plurality of orders;
the SSD engine obtaining order input data for each of the plurality of guests;
the SSD engine obtaining team member input data regarding each of one or more SSD employees assigned to staging and delivering curbside and in-store pickup orders at the retail store;
the SSD engine generating a prioritized sequence of staging tasks based on the guest input data, the order input data and the team member input data, wherein the prioritized sequence of staging tasks includes a plurality of staging tasks;
the SSD engine generating a prioritized sequence of delivery tasks based on the guest input data, the order input data and the team member input data, wherein the prioritized sequence of delivery tasks includes a plurality of delivery tasks;
the SSD engine assigning only one task from the combination of the plurality of delivery tasks and the plurality of staging tasks to a first SSD employee of the one or more SSD employees, wherein the one task is assigned by the SSD engine based on the guest input data, the order input data and the team member input data;
the SSD engine instructing a SSD graphical user interface (GUI) provided on a computing device of the first SSD employee to display the only one task;
the SSD engine receiving an accept selection, via the SSD GUI, indicating that the first SSD employee has accepted the only one task;
upon receiving the accept selection, the SSD engine monitoring progress and completion of the only one task; and
upon completion of the only one task, the SSD engine updating employee performance measurements, store leadership performance measurements, and SSD engine performance measurements based on the SSD monitoring the progress and completion of the only one task.

2. The computer-implemented method of claim 1, further comprising:
the SSD engine receiving a reject selection, via the SSD GUI, indicating that the first SSD employee has rejected the only one task;
upon receiving the reject selection, the SSD updating employee performance measurements, store leadership performance measurements, and SSD engine performance measurements based on the SSD employee rejecting the only one task.

3. The computer-implemented method of claim 2, further comprising the SSD engine removing the first SSD employee from the one or more SSD employees assigned to staging and delivering curbside and in-store pickup orders at the retail store.

4. The computer-implemented method of claim 1, wherein the guest input data includes at least one of: a number of guests that are on their way to the retail store or have arrived at the retail store; a distance or estimated time of arrival to the retail store for each guest; a priority level of each guest based on an On My Way (OMW) notification; and a multiple order delivery likelihood.

5. The computer-implemented method of claim 1, wherein the order input data includes at least one of: unit/order types; quantity of each unit/order; cubic volume of each unit/order; and hold/current location.

6. The computer-implemented method of claim 1, wherein the team member input data includes at least one of: a number of one or more SSD employees assigned to staging and delivering curbside and in-store pickup orders at the retail store; task type performance measurements for of the one or more SSD employees; a recent task type performed by each of the one or more SSD employees; a task preference for each of the one or more SSD employees; physical restrictions for each of the one or more SSD employees; and a time of year.

7. The computer-implemented method of claim 1, wherein the SSD engine updating the employee performance measurements includes updating at least one of: a percentage of tasks completed by the first SSD employee within a provided time estimate; a percentage of tasks accepted or rejected by the first SSD employee; and a percentage of task start delays within a delay time period.

8. The computer-implemented method of claim 1, wherein the SSD engine updating the store leadership performance measurements includes updating at least one of: a percentage of orders delivered within a maximum time threshold; a percentage of orders delivered within a derived time goal; a percentage of SSD employees completing tasks within the provided time estimate; and a ratio of actual SSD employee hours available to the needed SSD employee hours.

9. The computer-implemented method of claim 1, wherein the SSD engine updating the SSD engine performance measurements includes updating at least one of: a percentage of guests waiting beyond an acceptable or a desired time goal; and an accuracy of provided time estimates for task completion.

10. A system configured to increase order fulfillment efficiency for curbside or in-store pickup at a retail store, the system comprising:
a smart staging and delivery (SSD) engine configured to:
receive a plurality of orders for curbside delivery or in-store pickup at the retail store;
obtain guest input data for each of a plurality guests associated with each of the plurality of orders;
obtain order input data for each of the plurality of guests;
obtain team member input data regarding each of one or more SSD employees assigned to staging and delivering curbside and in-store pickup orders at the retail store;
generate a prioritized sequence of staging tasks based on the guest input data, the order input data and the team member input data, wherein the prioritized sequence of staging tasks includes a plurality of staging tasks;
generate a prioritized sequence of delivery tasks based on the guest input data, the order input data and the team member input data, wherein the prioritized sequence of delivery tasks includes a plurality of delivery tasks;
assign only one task from the combination of the plurality of delivery tasks and the plurality of staging tasks to a first SSD employee of the one or more SSD employees, wherein the one task is assigned by the SSD engine based on the guest input data, the order input data and the team member input data;
instruct a SSD graphical user interface (GUI) provided on a computing device of the first SSD employee to display the only one task;
receive an accept selection, via the SSD GUI, indicating that the first SSD employee has accepted the only one task;
monitor progress and completion of the only one task upon receiving the accept selection; and
update employee performance measurements, store leadership performance measurements, and SSD engine performance measurements based on the SSD monitoring the progress and completion of the only one task upon completion of the only one task.

11. The system of claim 10, wherein the SSD engine is further configured to:
receive a reject selection, via the SSD GUI, indicating that the first SSD employee has rejected the only one task;
update employee performance measurements, store leadership performance measurements, and SSD engine performance measurements based on the SSD employee rejecting the only one task upon receiving the reject selection.

12. The system of claim 10, wherein the SSD engine is further configured to remove the first SSD employee from the one or more SSD employees assigned to staging and delivering curbside and in-store pickup orders at the retail store.

13. The system of claim 10, wherein the guest input data includes at least one of: a number of guests that are on their way to the retail store or have arrived at the retail store; a distance or estimated time of arrival to the retail store for each guest; a priority level of each guest based on an On My Way (OMW) notification; and a multiple order delivery likelihood.

14. The system of claim 10, wherein the order input data includes at least one of: unit/order types; quantity of each unit/order; cubic volume of each unit/order; and hold/current location.

15. The system of claim 10, wherein the team member input data includes at least one of: a number of one or more SSD employees assigned to staging and delivering curbside and in-store pickup orders at the retail store; task type performance measurements for of the one or more SSD employees; a recent task type performed by each of the one or more SSD employees; a task preference for each of the one or more SSD employees; physical restrictions for each of the one or more SSD employees; and a time of year.

16. The system of claim 10, wherein the SSD engine is configured to update the employee performance measurements by updating at least one of: a percentage of tasks completed by the first SSD employee within a provided time estimate; a percentage of tasks accepted or rejected by the first SSD employee; and a percentage of task start delays within a delay time period.

17. The system of claim 10, wherein the SSD engine is configured to update the store leadership performance measurements by updating at least one of: a percentage of orders delivered within a maximum time threshold; a percentage of orders delivered within a derived time goal; a percentage of SSD employees completing tasks within the provided time estimate; and a ratio of actual SSD employee hours available to the needed SSD employee hours.

18. The system of claim 10, wherein the SSD engine is configured to update the SSD engine performance measurements by updating at least one of: a percentage of guests waiting beyond an acceptable or a desired time goal; and an accuracy of provided time estimates for task completion.
